(19) United States
(12) Patent Application Publication
(10) Pub. No.: US 2012/0185799 A1
(43) Pub. Date: Jul. 19, 2012

(54) MANAGING WINDOWS IN VIRTUAL ENVIRONMENT

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/220,626

(22) Filed: Aug. 29, 2011

(30) Foreign Application Priority Data
Jan. 14, 2011 (TW) 100101322

(51) Int. Cl. G06F 3/048

(52) U.S. Cl. 715/804

(57) ABSTRACT

In a virtual environment, a virtual machine (VM) host includes a host screen and a first host window displayed in the host screen. AVM guest is instantiated on the VM host. The VM guest includes a guest screen that is presented in the first host window and a guest window displayed in the guest screen. The VM guest captures a snapshot of the guest window when the guest window is inactive. The VM host creates a second host window and displays it in the host screen. The VM host presents the snapshot in the second host window. The VM guest activates the guest window when the second host window is selected.

### BACKGROUND

1. Technical Field

The disclosure generally relates to a method and a system for managing windows in a virtual environment.

2. Description of Related Art

A virtualization technique in which a plurality of virtual machines are installed on a physical computer makes each of the virtual machines run an arbitrary operating system (OS) and arbitrary software applications. A typical virtual system can operate multiple virtual machine (VM) guests by installing a VM host with a host OS for operating the VM guests. Each of the VM guests may include a guest OS and one or more software applications that are installed and executable in the VM Guest. The VM host may provide a host window displayed as a guest screen for each VM guest. The VM guest may run multiple software applications in the host window. One software application may form a guest window displayed in the host window to play as a user interface (UI) for the software application. However, since there is only a single host window for a single VM guest, and when the virtual system instantiates more than one VM guest and each VM guest runs a great number of software applications and creates a great number of guest windows for these software applications, switching to a particular running application in a particular VM guest becomes inconvenient for a user. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computer system in which virtual machines are configured.

FIG. 2 illustrates a view of one embodiment of a graphic user interface for displaying guest windows in the host windows in a host screen of the VM host.

FIG. 3 illustrates a first view of one embodiment of a graphic user interface for displaying snapshots of guest windows in the host windows in a host screen of the VM host.

FIG. 4 illustrates a second view of one embodiment of a graphic user interface for displaying snapshots of guest windows in the host windows in a host screen of the VM host.

FIG. 5 illustrates a third view of one embodiment of a graphic user interface for displaying snapshots of guest windows in the host windows in a host screen of the VM host.

FIG. 6 is an operational flow diagram representing an exemplary embodiment of a method of managing windows in the computer system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

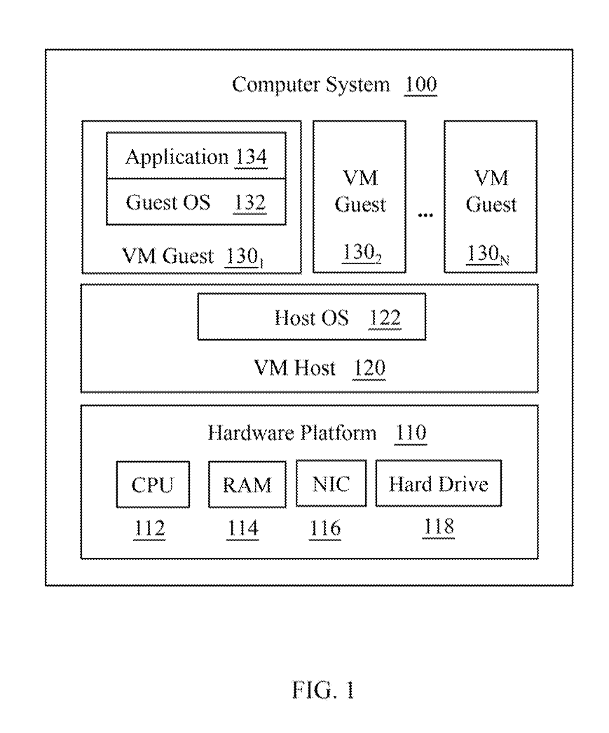

FIG. 1 depicts a block diagram of virtual machines that are configured on a computer system 100. The computer system 100 may be constructed on a desktop, a laptop or a server grade hardware platform 110 such as an x86 architecture platform. Such a hardware platform may include a central processing unit (CPU) 112, a random access memory (RAM) 114, a network interface controller (NIC) 116 (also referred to herein as a network card), a hard drive 118 and other I/O devices such as a mouse and a keyboard (not shown in FIG. 1).

The computer system 100 can operate one or more virtual machine (VM) guests 130₁, 130₂ . . . 130_{N}, collectively designated by a reference numeral 130, by installing a VM host 120 with a host operating system (OS) 122 for operating the VM guests 130. Each of the VM guests 130 may include a guest OS and one or more software applications. For example, the VM guest 130₁ includes a guest OS 132 and an application 134 that is installed and executable in the VM guest 130₁.

The VM host 120 may control the hardware platform 110, present to the VM guest 130 virtualized hardware resources, and manage the execution of the VM guests 130 and any of them. Multiple instances of the VM guests 130 may share the virtualized hardware resources and each of them may execute programs like a physical machine.

The VM host 120 may provide a host window displayed as a guest screen for each of the VM guests 130. Each of the VM guests may run multiple software applications in the corresponding host window. One software application may form a guest window displayed in the host window to play as a user interface for itself.

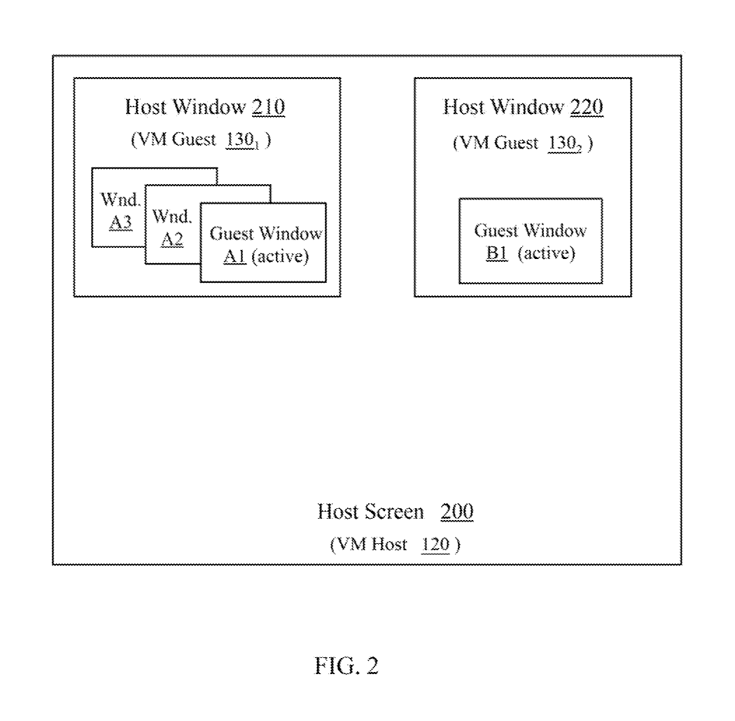

In FIG. 2, one embodiment of a graphic user interface for displaying guest windows in the host windows in a host screen 200 of the VM host 120 is shown. In one embodiment, the VM guest 130₁ and the VM guest 130₂ are concurrently instantiated on the VM host 120. The VM host 120 may provide a host window 210 for the VM guest 130₁ and a host window 220 for the VM guest 130₂, both of which are displayed in the host screen 200. The VM guest 130₁ is executing three software applications, which form guest windows A1, A2, and A3. The three guest windows are displayed in the host window 210. The VM guest 130₂ is executing one application, which forms a guest window B1 displayed in the host window 220. As shown in FIG. 2, the guest window A1 is active and laid on the frontmost in the host window 210. The guest windows A2 and A3 are inactive and laid on the rear side of the guest window A1.

The computer system 100 may assign a unique Internet protocol (IP) address for each of the VM guests 130 manually or automatically. The computer system may create an Address Resolution Protocol (ARP) table that stores and maintains all the IP addresses of the VM guests 130. The ARP table may further store a VM ID or a MAC address corresponding to the unique IP address for each VM guest. The VM ID is an identification key to identify a unique VM guest. The MAC address is assigned by the VM host 120 when the corresponding VM guest is created. Each of the VM guests 130 has a unique MAC address which can be recognized in a local area network (LAN) or a wide area network (WAN) such as the Internet. The IP address of a VM guest can be acquired from the ARP table according to either the VM ID or the MAC address of the VM guest.

The VM host 120 may establish a connection channel based on a transmission control protocol (TCP) between the VM host 120 and each of the VM guests 30. For example, when a connection channel is established between the VM host 120 and the VM guest 130₁, the VM host 120 and the VM guest 130₁ can communicate with each other.

When any guest window of a VM guest becomes inactive, the VM guest may capture a snapshot of the inactive guest window and transmit the snapshot and corresponding information about the inactive guest window to the VM host 120 via the connection channel. The corresponding information about the inactive guest window may include the window name, the window position, and the window size, and information as to the application running in the inactive guest window.

The VM host 120 may create a host window in its host screen and display the snapshot received from the VM guest in the host window. The VM host 120 may correlate the host window to the corresponding information about the inactive guest window.

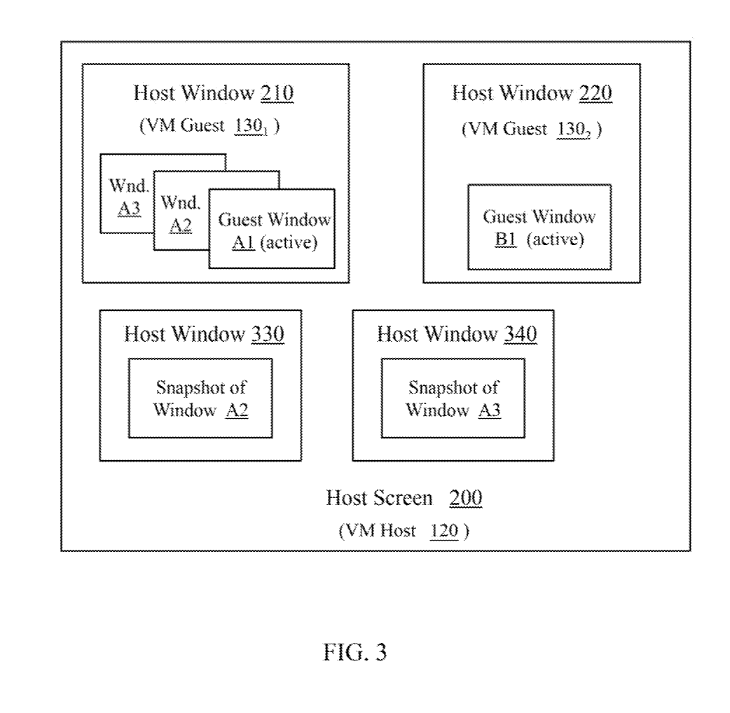

In FIG. 3, a first view of one embodiment of a graphic user interface for displaying snapshots of guest windows in the host windows in the host screen of the VM host 120 is shown. As depicted in FIG. 3, the host window 210 is presenting three guest windows A1, A2 and A3. The guest window A1 is active and the other two guest windows are inactive. The VM guest 130₁ captures snapshots of the guest windows A2 and A3 and transmits the two snapshots and corresponding information about the two guest windows to the VM host 120. The VM host 120 creates a host window 330 and a host window 340 respectively for the two inactive guest windows A2 and A3. The VM host 120 displays the snapshot of the guest window A2 in the host window 330 and correlates the host window 330 to the corresponding information about the guest window A2. In a similar way, the VM host 120 displays the snapshot of the guest window A3 in the host window 340 and correlates the host window 340 to the corresponding information about the guest window A3.

The VM guest 1301 may continually capture snapshots of the inactive guest windows at predetermined intervals such as 10 seconds while the guest windows are inactive, and send the captured snapshots to the VM host 120. The VM host 120 may update the snapshots presented in the corresponding host windows accordingly.

When a user selects one of the host windows 330 and 340, the VM host 120 may send an activation request for activating a guest window, which is correlated to the selected host window, to the VM gust 130₁ via the connection channel. In response to the activation request, the VM guest 130₁ can activate the corresponding guest window.

With reference to FIG. 3, if the user selects the host window 340 by clicking or touching a portion of the host window 340, the host VM host 120 will send an activation request for activating the guest window A3 to the VM guest 130₁.

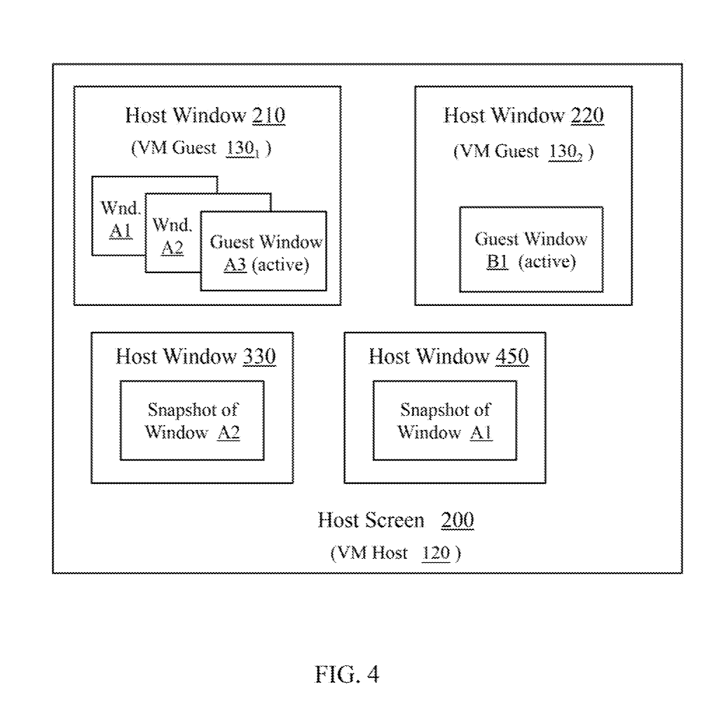

FIG. 4 illustrates a view of a graphic user interface for displaying snapshots of guest windows in the host windows in the host screen of the VM host 120 when the VM guest 130₁ receives an activation request for activating the guest window A3. In response to the activation request, the VM guest 130₁ activates the guest window A3 in the host window 210. The guest window A3 thus becomes active and the guest window A1 becomes inactive. The VM host 120 may destroy the host window 340 when the correlated guest window A3 becomes active. When the guest window A1 becomes inactive, the VM guest 130₁ may capture a snapshot of the guest window A1 and transmit the snapshot to the VM host 120. As shown in FIG. 4, the VM host 120 may create a host window 450 to display the snapshot of the guest window A1 and associate the host window 450 with the corresponding information about the guest window A1.

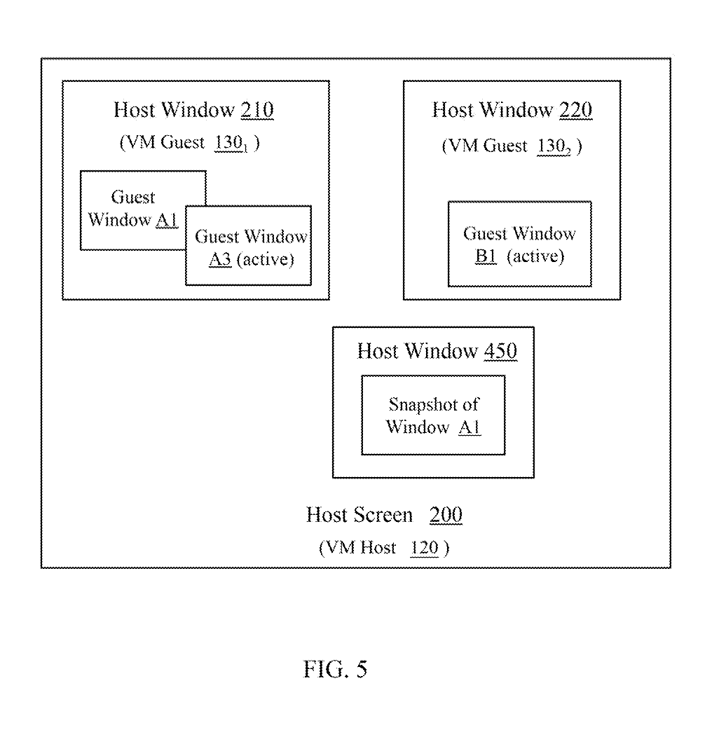

With reference to FIG. 4, if one of the inactive guest windows A1 and A2 is closed, the VM guest 130₁ may send a window close message to the host VM host 120. In response to the window close message, the VM host 120 can destroy a host window, which is correlated to the guest window to be closed. For example, if the user closes the guest window A2, the VM host 120 may destroyed the host window 330, which is correlated to the guest window A2. FIG. 5 shows that the guest window A2 has been closed and the host window 330 has been destroyed as well.

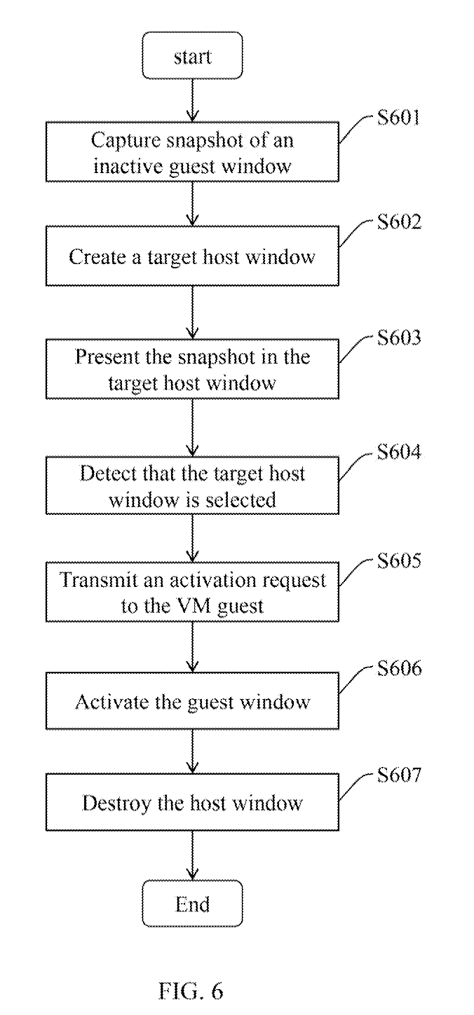

FIG. 6 is a flowchart illustrating one embodiment of a method of managing windows in the computer system 100. The method may include the following steps.

In step S601, the VM guest 130₁ captures a snapshot of a guest window when the guest window becomes inactive, and transmits the snapshot and corresponding information about the inactive guest window to the VM host 120 via the connection channel.

In step S602, the VM host 120 creates a target host window and displays the target host window in the host screen 200.

In step S603, the VM host 120 presents the snapshot in the target host window and correlates the target host window with the corresponding information about the inactive guest window.

In step S604, the VM host 120 detects that the target host window has been selected.

In step S605, the VM host 120 sends an activation request for activating the inactive guest window, which is correlated to the selected target host window, to the VM gust 130₁ via the connection channel.

In step S606, the VM gust 130₁ activates the inactive guest window.

In step S607, the VM host 120 destroys the target host window.

Although numerous characteristics and advantages have been set forth in the foregoing description of the embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A method for managing windows in a computer system, the computer system having a virtual machine (VM) host and a VM guest instantiated on the VM host, the VM host having a host screen and a first host window displayed in the host screen, the VM guest having a guest screen that is presented in the first host window and a guest window displayed in the guest screen, the method comprising:
capturing a snapshot of the guest window by the VM guest when the guest window is inactive;
creating and displaying a second host window in the host screen by the VM host;
presenting the snapshot in the second host window by the VM host; and
activating the guest window by the VM guest when the second host window is selected.

2. The method of claim 1, further comprising destroying the second host window by the VM host when the guest window becomes active.

3. The method of claim 1, further comprising establishing a connection channel between the VM host and the VM guest.

4. The method of claim 3, further comprising transmitting the snapshot to the VM host via the connection channel by the VM guest.

5. The method of claim 3, further comprising transmitting an activation request for activating the guest window to the VM guest via the connection channel by the VM host when the second host window becomes active.

6. The method of claim 3, wherein the connection channel is based on Transmission Control Protocol (TCP).

7. The method of claim 1, further comprising continually capturing the snapshot of the guest window at predetermined intervals by the VM guest while the guest window is inactive, and updating the snapshot presented in the second host window by the VM host.

8. A computer system comprising:
a virtual machine (VM) host having a host screen and a first host window displayed in the host screen;
a VM guest instantiated on the VM host, the VM guest having a guest screen that is presented in the first host window and a guest window displayed in the guest screen;
wherein the VM guest is configured to capture a snapshot of the guest window when the guest window is inactive, the VM host is adapted to create a second host window displayed in the host screen and present the snapshot in the second host window; and
wherein the VM guest is further adapted to activate the guest window when the second host window is selected.

9. The computer system of claim 8, wherein the VM host is further configured to destroy the second host window when the guest window becomes active.

10. The computer system of claim 8, wherein the VM host is further configured to establish a connection channel between the VM host and the VM guest.

11. The computer system of claim 10, wherein the VM guest is further configured to transmit the snapshot to the VM host via the connection channel.

12. The computer system of claim 10, wherein the VM host is further configured to transmit an activation request for activating the guest window to the VM guest via the connection channel when the second host window becomes active.

13. The computer system of claim 10, wherein the connection channel is based on Transmission Control Protocol (TCP).

14. The computer system of claim 10, wherein the VM guest is further configured to continually capture the snapshot of the guest window at predetermined intervals while the guest window is inactive, and the VM host is further adapted to update the snapshot presented in the second host window.

15. A non-transitory storage medium having stored thereon instructions that, when executed by a processor of a computer system, cause the computer system to perform a method for managing windows, the computer system having a virtual machine (VM) host and a VM guest instantiated on the VM host, the VM host having a host screen and a first host window displayed in the host screen, the VM guest having a guest screen that is presented in the first host window and a guest window displayed in the guest screen, the method comprising:
capturing a snapshot of the guest window by the VM guest when the guest window is inactive;
creating a second host window displayed in the host screen by the VM host;
presenting the snapshot in the second host window by the VM host; and
activating the guest window by the VM guest when the second host window is selected.

16. The non-transitory storage medium of claim 15, wherein the method further comprises destroying the second host window by the VM host when the guest window becomes active.

17. The non-transitory storage medium of claim 15, wherein the method further comprises establishing a connection channel between the VM host and the VM guest.

18. The non-transitory storage medium of claim 17, wherein the method further comprises transmitting the snapshot to the VM host via the connection channel by the VM guest.

19. The non-transitory storage medium of claim 17, wherein the method further comprises transmitting an activation request for activating the guest window to the VM guest via the connection channel by the VM host when the second host window becomes active.

20. The non-transitory storage medium of claim 15, wherein the method further comprises continually capturing the snapshot of the guest window at predetermined intervals by the VM guest while the guest window is inactive, and updating the snapshot presented in the second host window by the VM host.
